(19) United States
(12) Patent Application Publication
(10) Pub. No.: US 2013/0181446 A1
(43) Pub. Date: Jul. 18, 2013

(54) QUICK-CONNECT COUPLER

(71) Applicant: Pascal LE CLINCHE, Orleans (FR)

(72) Inventor: Pascal LE CLINCHE, Orleans (FR)

(73) Assignee: COMAP, Lyon (FR)

(21) Appl. No.: 13/349,663

(22) Filed: Jan. 13, 2012

(51) Int. Cl. F16L 21/06

(52) U.S. Cl. 285/345

(57) ABSTRACT

The invention relates to a quick-connect coupler for at least one tube, including a tubular body having at least one receiving portion shaped to receive an end segment of the tube, the receiving portion being at least partially made from a transparent material, so as to make it possible to view the end segment of the tube when the latter is received in the receiving portion, and a retaining member mounted inside the receiving portion, arranged to oppose the withdrawal of the tube when a pulling force is exerted on the tube.

### TECHNICAL FIELD

The present invention relates to a quick-connect coupling for at least one tube.

### BRIEF DISCUSSION OF RELATED ART

Such a coupling is, for example, applicable for the fluid connection of the tube to a device, such as a tap or a collector, or for the fluid connection of tubes of an irrigation or potable water distribution network.

A quick-connect coupling, known in the state of the art, comprises a tubular body having a receiving portion shaped to receive an end segment of the tube. The coupling comprises a ring, mounted inside the body, equipped with prongs. These prongs are arranged to oppose the withdrawal of the tube when a pulling force is exerted on said tube.

In usage conditions, a user engages an end segment of a tube in the receiving portion. The user then has no means to judge the engaged length of the tube.

In the event the tube is insufficiently engaged, the flow of pressurized fluid inside that tube can lead to its expulsion outside the receiving portion.

### BRIEF SUMMARY

The present invention aims to offset this drawback.

The invention relates to a quick-connect coupling for at least one tube, comprising:

a tubular body having at least one receiving portion shaped to receive an end segment of the tube, the receiving portion being at least partially made from a transparent material, so as to make it possible to view the end segment of the tube when the latter is received in the receiving portion; and

a retaining member mounted inside the receiving portion, arranged to oppose the withdrawal of the tube when a pulling force is exerted on said tube.

In the description, the term “transparent” must be understood as allowing the light waves of the visible domain, i.e. 380 nm to 780 nm, to pass.

When a user engages the end segment of the tube in the receiving portion of the body, that user can judge, by looking through the part of the receiving portion, the engaged length of the tube. The user can then verify that the engagement of the tube in the body is sufficient to ensure its retention in usage conditions.

The coupling according to the invention can also comprise one or more of the following features.

In one preferred embodiment, the receiving portion of the body is made completely from a transparent material.

Under these conditions, the user can view the end segment of the tube engaged the receiving portion of the body in its entirety.

According to one feature, the coupling comprises a cap made from an opaque material, mounted on the body and arranged to at least partially reveal the receiving portion.

In the description, the term “opaque” must be understood as capable of reflecting the light waves of the visible domain.

In one embodiment, the body is completely made from a transparent material.

According to one possibility, the body has a connecting portion connected to said receiving portion, and the cap is arranged to reveal the connecting portion in its entirety.

According to another possibility, the body has a connecting portion connected to said receiving portion, and the cap is arranged to conceal the entire connecting portion.

Such an arrangement allows the user to view the engagement of the tube in the receiving portion, while protecting the fluid from the light rays.

Such an arrangement makes it possible to limit bacterial growth of the fluid, and to subsequently guarantee the hygiene of the fluid. This coupling is then perfectly adapted to be used in a potable water distribution network.

For example, the receiving portion comprises a first part turned toward the connecting portion, and the second part opposite the first part, and the cap comprises:

a first element arranged to conceal the second part of the receiving portion; and

a second element arranged to conceal the connecting portion in its entirety, and having at least one opening to reveal the first part of the receiving portion.

In another embodiment, the coupling comprises a sleeve, made from an opaque material, fluidly connected to the receiving portion.

Advantageously, the receiving portion comprises a first part turned toward the sleeve, and a second part opposite the first part, and the cap comprises an element arranged to conceal the second part of the receiving portion and reveal the first part of the receiving portion.

According to one feature, the retaining member comprises a ring equipped with prongs arranged to push into the wall of the tube when a pulling force is exerted on said tube.

According to another feature, the coupling comprises a sealing device inside the receiving portion, arranged to ensure sealing between the body and the tube when the latter is received in the receiving portion.

The invention also relates to the use of the coupling as presented above in an irrigation network.

The invention lastly relates to the use of the coupling as presented above in a potable water distribution network.

### BRIEF DESCRIPTION OF THE DRAWINGS

The invention will be better understood using the following description in reference to the appended diagrammatic drawings showing, as an example, three embodiments of a quick-connect coupling according to the invention.

FIG. 1 is a side view of a first quick-connect coupling according to the invention;

FIG. 2 is a longitudinal cross-sectional view of the coupling of FIG. 1;

FIG. 3 is a perspective view of an alternative of the coupling of FIG. 1;

FIG. 4 is a perspective view of another alternative of the coupling of FIG. 1;

FIG. 5 is a side view of a second quick-connect coupling according to the invention;

FIG. 6 is a longitudinal cross-sectional view of the coupling of FIG. 5;

FIG. 7 is a side view of an alternative of the coupling of FIG. 5;

FIG. 8 is a perspective view of a third quick-connect coupling according to the invention;

FIG. 9 is a longitudinal cross-sectional view of the coupling of FIG. 8;

FIG. 10 is a side view of an alternative of the coupling of FIG. 8; and

FIG. 11 is a side view of another alternative of the coupling of FIG. 1.

### DETAILED DESCRIPTION

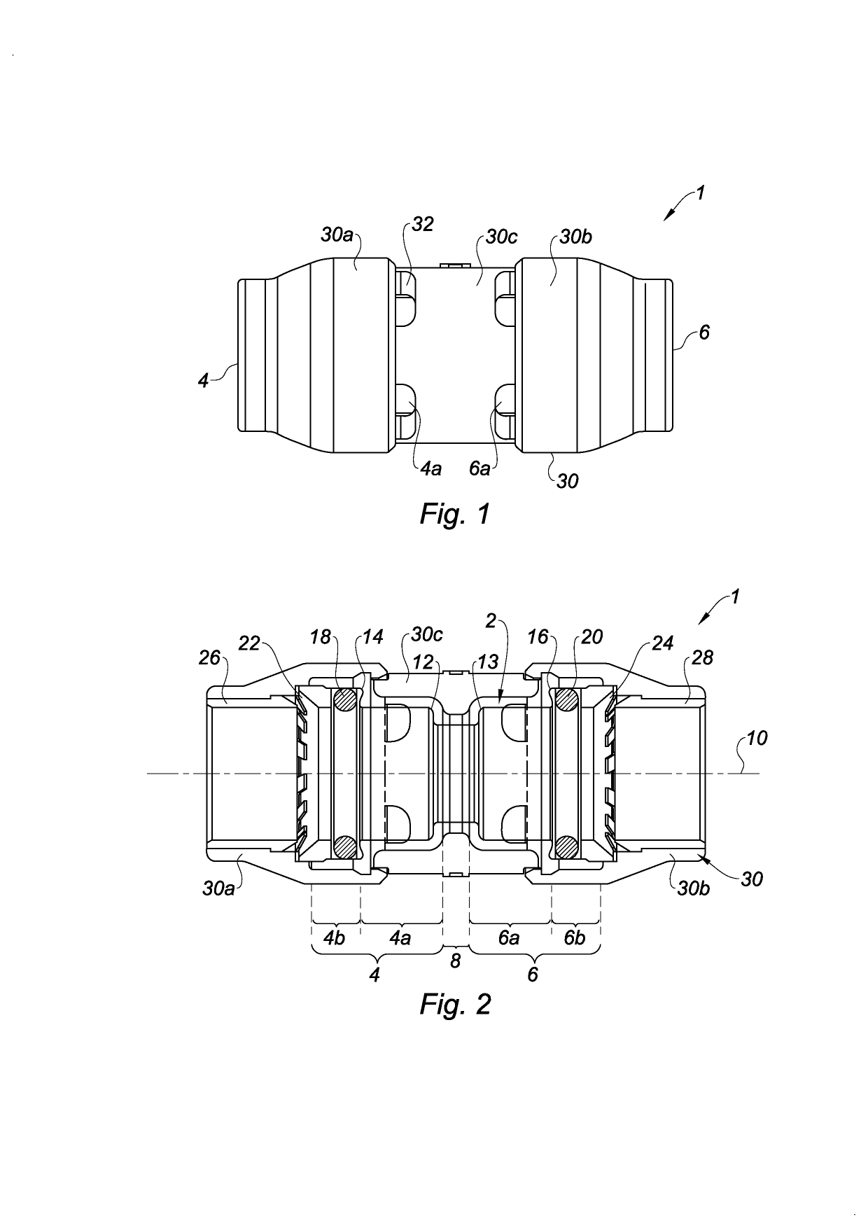

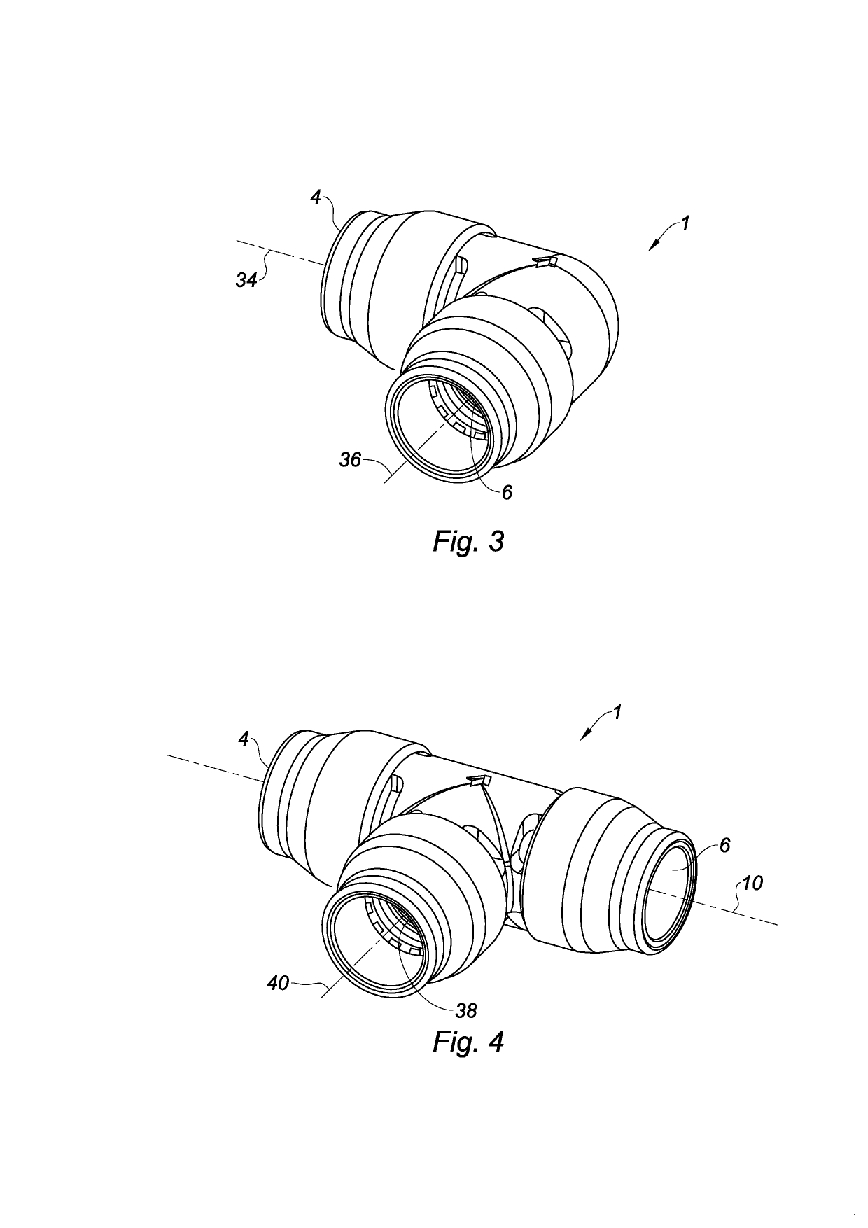

FIGS. 1 and 2 show a quick-connect coupling 1 for the fluid connection of two tubes of an irrigation network or a potable water distribution network.

The coupling 1 comprises a tubular body 2 made from a transparent plastic material. Here, the body 2 is made from clarified polypropylene. Alternatively, the body 2 can be made from polyamide, polysulfone, polyphenylsulfone (PPSU), or others.

The body 2 has two receiving portions 4 and 6 shaped to receive an end segment of the tube, and a connecting portion 8 connecting the receiving portions 4 and 6. The receiving portions 4 and 6 extend along a same axis 10. The receiving portions 4 and 6 respectively comprise parts 4a and 6a turned toward the connecting portion 8. The receiving portions 4 and 6 respectively comprise parts 4b and 6b opposite the parts 4a and 6a.

The inner diameter of the parts 4a and 6a is larger than the inner diameter of the connecting portion 8, forming shoulders 12 and 13. The inner diameter of the parts 4a and 6a is smaller than the inner diameter of the parts 4b and 6b, forming shoulders 14 and 16.

The coupling 1 comprises sealing devices 18 and 20 mounted inside the receiving portions 4 and 6, bearing against the shoulders 14 and 16. Here, the seals 18 and 20 are O-rings.

The coupling 1 comprises retaining members 22 and 24 mounted inside the receiving portions 4 and 6, respectively. The retaining members 22 and 24 assume the form of rings equipped with prongs.

The coupling 1 comprises two cylinders 26 and 28 fluidly connected to the parts 4a and 6a of the receiving portions 4 and 6, respectively. The cylinders 26 and 28 are designed to allow, if necessary, the withdrawal of a tube end segment received in one of the receiving portions 4 or 6.

As illustrated, the cylinders 26 and 28 have inner diameters equal to the inner diameters of the parts 4a and 6a of the receiving portions 4 and 6, respectively.

The coupling 1 lastly comprises a cap 30 mounted on the body. In the example, the cap is made up of tubular elements 30a, 30b and 30c. Alternatively, the cap 30 may be made from a single element.

The element 30a completely conceals the cylinder 26 and the part 4b of the receiving portion 4.

The element 30b completely conceals the cylinder 28 and the part 6b of the receiving portion 6.

The element 30c completely conceals the connecting portion 8, and has a plurality of openings 32 revealing the parts 4a and 6a of the receiving portions 4 and 6.

The elements 30a, 30b and 30c are made from an opaque plastic material, such as polypropylene or polyethylene. Alternatively, the elements 30a, 30b and 30c can be made from polyamide, polysulfone, polyphenylsulfone (PPSU), or others.

The elements 30a, 30b and 30c are secured to the body 2 and the cylinders 26 and 28 by bi-material injection, ultrasound welding, or snapping. In usage conditions, a user engages an end segment of a tube inside the receiving portion 4, engaged until it bears against the shoulder 12.

The user can then view, through the openings 32 and by looking through the portion 4a, the end segment of the tube engaged in the receiving portion 4. In this way, the user can judge whether the tube has been pushed in to a satisfactory extent.

The seals 18 and 20 ensure sealing between the body 2 and the tube received in the receiving portion 4.

Furthermore, when a pulling force is exerted on the tube, the prongs of the retaining member 22 are pushed into the wall of the tube to oppose the withdrawal thereof.

FIG. 3 shows an alternative of the coupling 1, in which the receiving portions 4 and 6 do not extend along the same axis 10, but along perpendicular axes 34 and 36.

FIG. 4 shows another alternative of the coupling 1, in which the body 2 has an additional receiving portion 38. This receiving portion 38 extends along an axis 40 perpendicular to the axis 10.

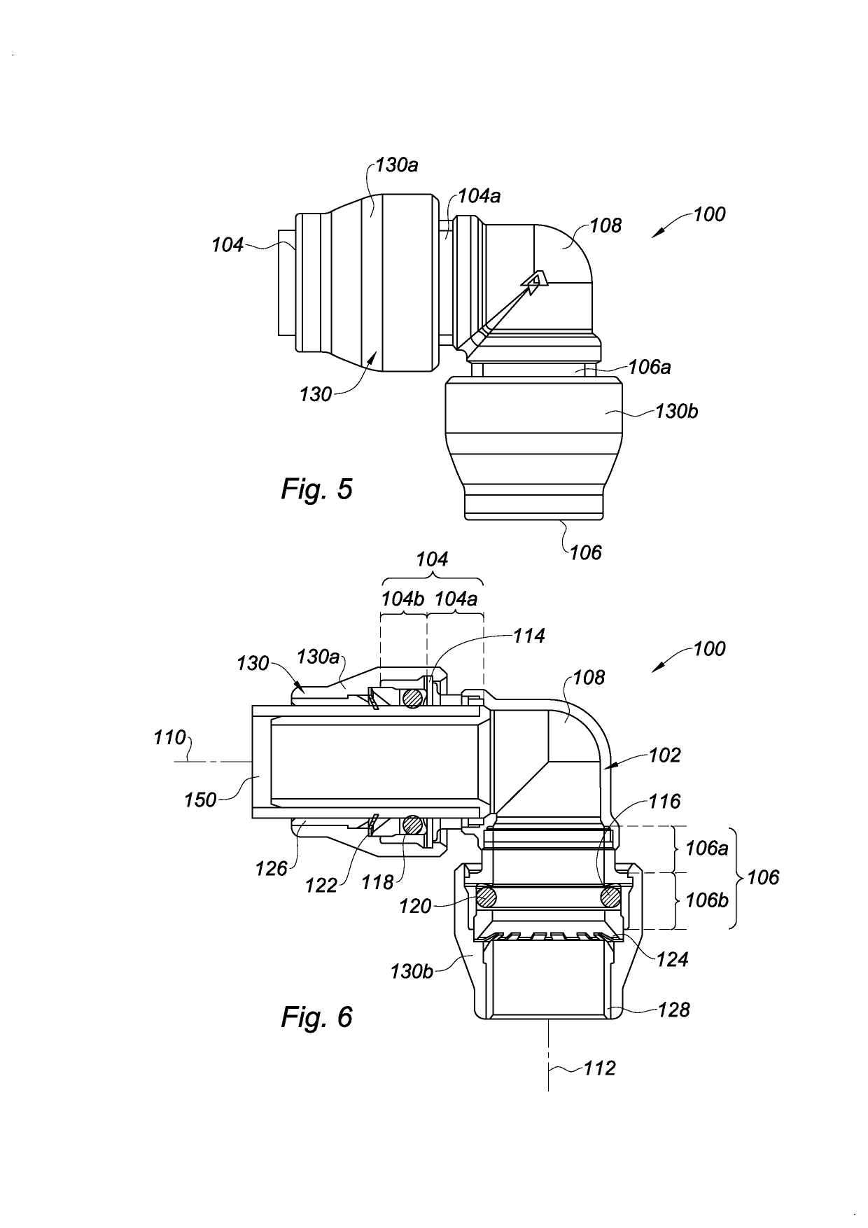

FIGS. 5 and 6 show a quick-connect coupling 100 for the fluid connection of two tubes of an irrigation network or a potable water distribution network.

The coupling 100 comprises a tubular body 102. The body 102 has two receiving portions 104 and 106 shaped to receive an end segment of a tube.

The body 102 also has a sleeve 108 fluidly connecting the receiving portions 104 and 106. Here, the sleeve 108 is bent.

The sleeve 108 is made from an opaque plastic material, such as polypropylene or polyethylene. Alternatively, the sleeve 108 can be made from polyamide, polysulfone, polyphenylsulfone (PSSU), or others.

The receiving portions 104 and 106 are made from a transparent plastic material, such as clarified polypropylene.

The receiving portions 104 and 106 extend along perpendicular axes 110 and 112.

The receiving portions 104 and 106 comprise parts 104a and 106a, respectively, turned toward the sleeve 108. The receiving portions 104 and 106 comprise parts 104b and 106b, respectively, opposite the parts 104a and 106a. The inner diameter of the parts 104a and 106a is smaller than the inner diameter of the parts 104b and 106b, forming shoulders 114 and 116.

The coupling 100 comprises sealing devices 118 and 120 mounted inside receiving portions 104 and 106, bearing against the shoulders 114 and 116. Here, the seals 118 and 120 are O-rings.

The coupling 100 comprises retaining members 122 and 124 mounted inside the receiving portions 104 and 106, respectively. The retaining members 122 and 124 assume the form of rings equipped with prongs. The function of the retaining members 122 and 124 will appear hereafter.

The coupling 100 comprises two cylinders 126 and 128 fluidly connected to the parts 104a and 106a of the receiving portions 104 and 106, respectively. The cylinders 126 and 128 are designed to allow, if necessary, the withdrawal of a tube end segment received in one of the receiving portions 4 or 6.

As shown, the cylinders 126 and 128 have an inner diameter equal to the inner diameters of the parts 104a and 106a of the receiving portions 104 and 106.

The coupling 100 lastly comprises a cap 130 mounted on the body 102. The cap is made up of tubular elements 130a and 130b.

The element 130a completely conceals the cylinder 126 and the part 104b of the receiving portion 104.

The element 130b completely conceals the cylinder 128 and the part 106b of the receiving portion 106.

The elements 130a and 130b are made from an opaque plastic material, such as polypropylene or polyethylene.

The elements 130a and 130b are secured to the body 102 and the cylinders 126 and 128 by bi-material injection, ultrasound welding, friction rotation welding, or snapping.

In usage conditions, the user engages an end segment of a tube 150 inside the receiving portion 104, until it bears against a shoulder of the sleeve 108.

The user can view, through the part 104a of the receiving portion 104, the end segment engaged in the receiving portion 104. In this way, the user can judge whether the end segment of the tube 150 has been pushed in to a satisfactory extent.

The seal 118 ensures sealing between the body 102 and the tube 150 received in the receiving portion 104.

When a pulling force is exerted on the tube, the prongs of the ring 122 are pushed into the wall of the tube 150 to oppose the withdrawal thereof.

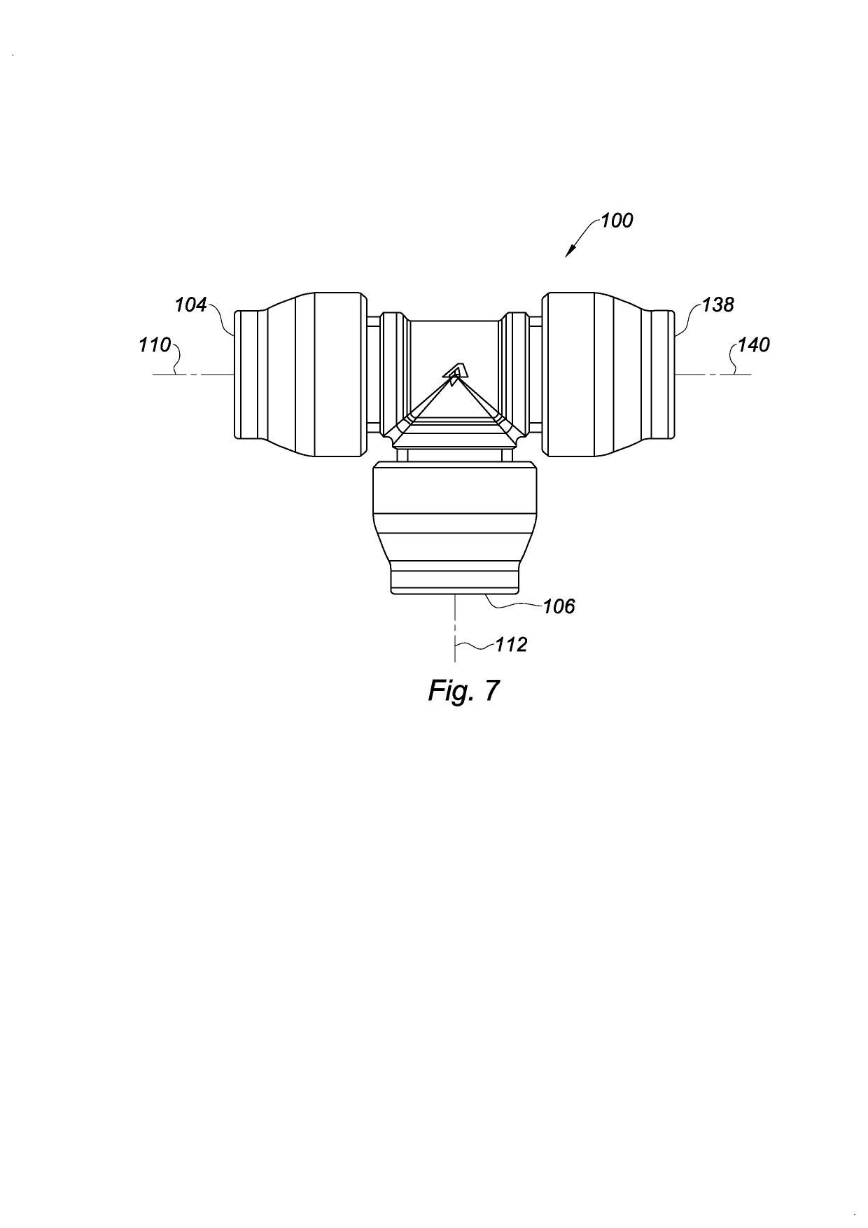

FIG. 7 shows an alternative of the coupling 100, in which the body 102 has an additional receiving portion 138. This receiving portion 138 extends along an axis 140 parallel to the axis 110.

Alternatively (not shown), the receiving portions 104 and 106 do not extend along perpendicular axes 110 and 112, but along a same axis.

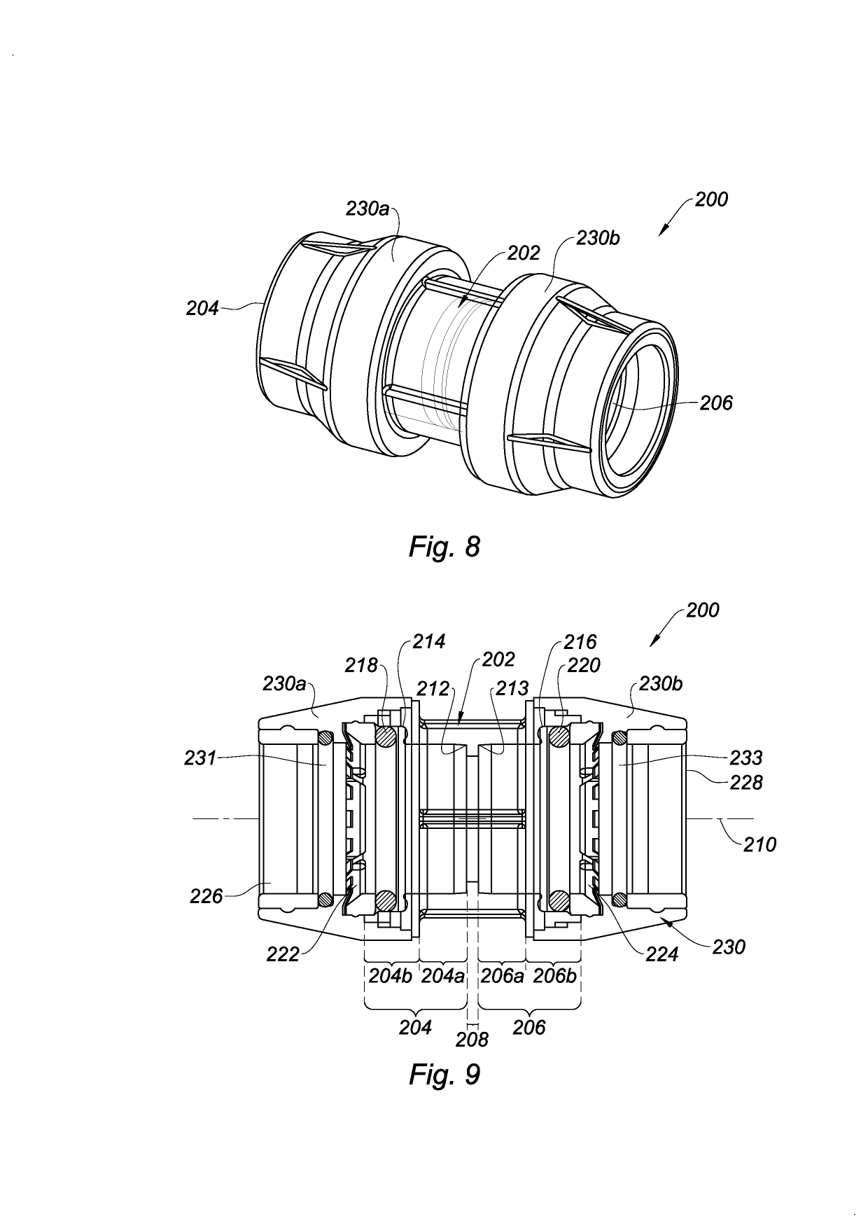

FIGS. 8 and 9 show a quick-connect coupling 200 for the fluid connection of two tubes of an irrigation network.

The coupling 200 comprises a tubular body 202 made from a transparent plastic material, such as clarified polypropylene.

The body 202 has two receiving portions 204 and 206 shaped to receive an end segment of a tube. The receiving portions 204 and 206 extend along a same axis 210.

The body 202 also has a connecting portion 208 connecting the receiving portions 204 and 206. The receiving portions 204 and 206 respectively comprise parts 204a and 206a turned toward the connecting portion 208. The receiving portions 204 and 206 respectively comprise parts 204b and 206b opposite the parts 204a and 206a.

The inner diameter of the parts 204a and 206a is larger than the inner diameter of the connecting portion 208, forming shoulders 212 and 213.

The inner diameter of the parts 204a and 206a is smaller than the inner diameter of the parts 204b and 206b, forming shoulders 214 and 216.

The coupling 200 comprises sealing devices 218 and 220 mounted inside the receiving portions 204 and 206, bearing against the shoulders 214 and 216. Here, the seals 218 and 220 are O-rings.

The coupling 200 comprises retaining members 222 and 224 mounted inside the receiving portions 204 and 206. The retaining members 222 and 224 assume the form of rings equipped with prongs.

The coupling 200 comprises two cylinders 226 and 228 fluidly connected to the parts 204 and 206a of the receiving portions 204 and 206, respectively. As shown, the cylinders 226 and 228 have an inner diameter equal to the inner diameters of the parts 204a and 206a of the receiving portions 204 and 206.

The coupling 200 lastly comprises a cap 230 mounted on the body 202. The cap 230 is made up of tubular elements 230a and 230b.

The element 230a completely conceals the cylinder 226 and the part 204b of the receiving portion 204.

The element 230b completely conceals the cylinder 228 and the part 206b of the receiving portion 206.

The elements 230a and 230b are made from an opaque plastic material, such as polypropylene or polyethylene.

The elements 230a and 230b are secured to the body 2 and the cylinders 26 and 28 by friction rotation welding, ultrasound welding, screwing or snapping.

A sealing device 231, here an O-ring, is pinched between the cylinder 226 and the element 230a so as to ensure sealing between the cylinder 226 and the element 230a. Likewise, a sealing device 233 is pinched between the cylinder 228 and the element 230b. Such a seal, called an anti-moisture scraper, makes it possible to protect the retaining members 222 and 224, which are traditionally made from metal, against corrosion. Such an arrangement is particularly advantageous when the coupling 200 is buried.

In usage conditions, a user engages an end segment of a tube inside the receiving portion 204, until it bears against the shoulder 212.

The user can view, by looking through the portion 204a, the end segment of the tube engaged in the receiving portion 204, and thus judge whether the tube is pushed in to a sufficient extent.

The seals 218 and 220 ensure sealing between the body 2 and the tubes received the received in the portions 4 and 6.

When a pulling force is exerted on the tubes, the prongs of the rings 222 and 224 are pushed into the wall of the tube to oppose the withdrawal of said tube.

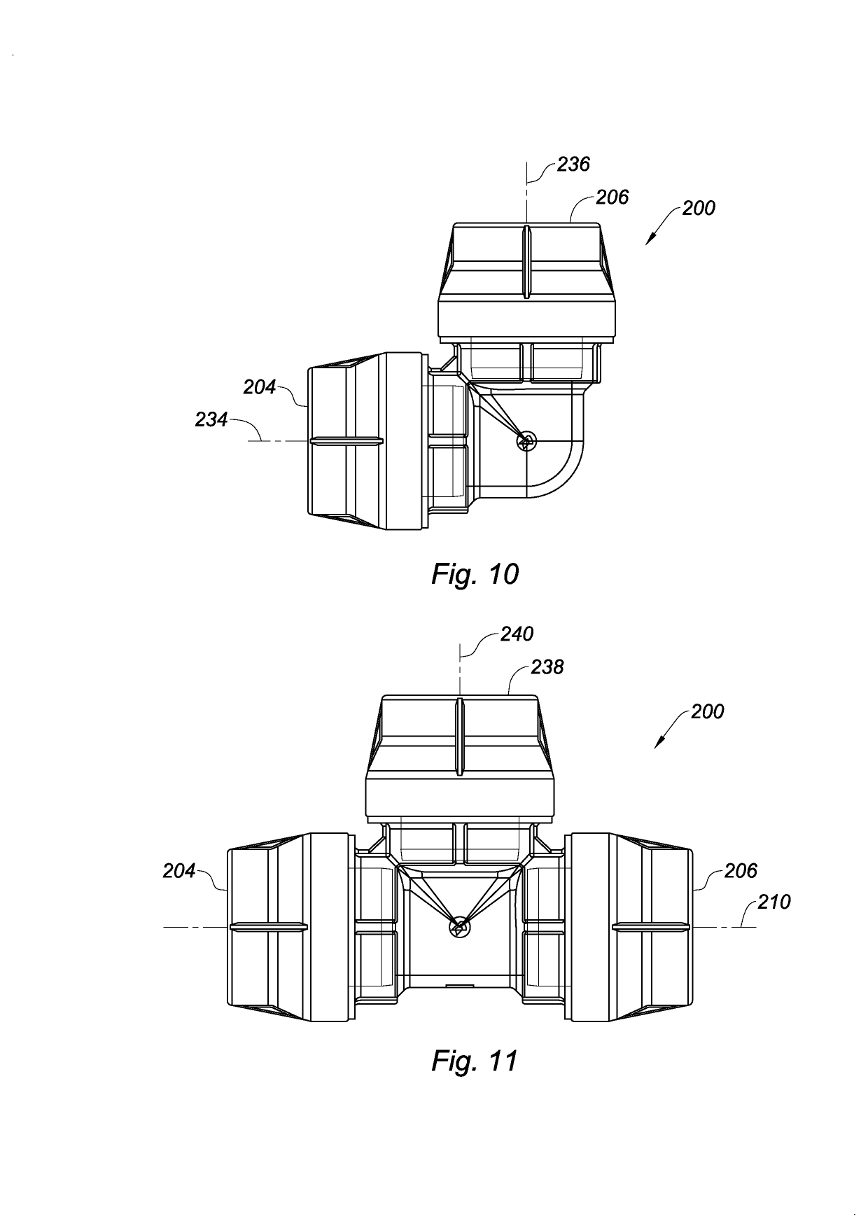

FIG. 10 shows an alternative of the coupling 200, in which the receiving portions 204 and 206 no longer extend along the same axis 210, but along perpendicular axes 234 and 236.

FIG. 11 shows another alternative of the coupling 200, in which the body 202 has an additional receiving portion 238. This receiving portion 238 extends along an axis 240 perpendicular to the axis 210.

The invention is of course not limited solely to the embodiments of the coupling described above as examples, but on the contrary encompasses all alternative embodiments.

1. A quick-connect coupling for at least one tube, comprising:
a tubular body having at least one receiving portion shaped to receive an end segment of the tube, the receiving portion being at least partially made from a transparent material, so as to make it possible to view the end segment of the tube when the latter is received in the receiving portion; and
a retaining member mounted inside the receiving portion, arranged to oppose A withdrawal of the tube when a pulling force is exerted on said tube.

2. The coupling according to claim 1, wherein the receiving portion of the body is made completely from a transparent material.

3. The coupling according to claim 2, comprising a cap made from an opaque material, mounted on the body and arranged to at least partially reveal the receiving portion.

4. The coupling according to claim 3, wherein the body is completely made from a transparent material.

5. The coupling according to claim 4, wherein the body has a connecting portion connected to said receiving portion, and the cap is arranged to reveal the connecting portion in its entirety.

6. The coupling according to claim 4, wherein the body has a connecting portion connected to said receiving portion, and the cap is arranged to conceal the entire connecting portion.

7. The coupling according to claim 6, wherein the receiving portion comprises a first part turned toward the connecting portion, and the second part opposite the first part, and the cap comprises: a first element arranged to conceal the second part of the receiving portion; and a second element arranged to conceal the connecting portion in its entirety, and having at least one opening to reveal the first part of the receiving portion.

8. The coupling according to claim 3, comprising a sleeve, made from an opaque material, fluidly connected to the receiving portion of the body.

9. The coupling according to claim 8, wherein the receiving portion comprises a first part turned toward the sleeve, and a second part opposite the first part, and the cap comprises an element arranged to conceal the second part of the receiving portion and reveal the first part of the receiving portion.

10. The coupling according to claim 1, wherein the retaining member comprises a ring equipped with prongs arranged to push into the wall of the tube when a pulling force is exerted on said tube.

11. The coupling according to claim 1, comprising a sealing device inside the receiving portion, arranged to ensure sealing between the body and the tube when the latter is received in the receiving portion.

12. The coupling according to claim 1, wherein the coupling is disposed in an irrigation network.

13. The coupling according to claim 1, wherein the coupling is disposed in a potable water distribution network.
